(19) United States
(12) Patent Application Publication
(10) Pub. No.: US 2017/0336428 A1
(43) Pub. Date: Nov. 23, 2017

(54) RFID Tracking Systems And Methods

(71) Applicant: Roche Molecular Systems, Inc., Pleasanton, CA (US)

(72) Inventors: Stanford Kwang, Pleasanton, CA (US); Wouter Pattje, Livermore, CA (US)

(73) Assignee: Roche Molecular Systems, Inc., Pleasanton, CA (US)

(21) Appl. No.: 15/598,449

(22) Filed: May 18, 2017

Related U.S. Application Data
(60) Provisional application No. 62/338,620, filed on May 19, 2016.

(51) Int. Cl. G01N 35/00

(52) U.S. Cl. CPC G01N 35/00663; G01N 35/00732; G01N 2035/00673; G01N 2035/00811; G01N 2035/00742

(57) ABSTRACT

Improved component tracking methods and systems are disclosed herein. The use of suspended reagent and/or sample identifiers are described as well as the use of suspended and supplemental identifiers to enhance component tracking in assay systems.

### CROSS-REFERENCE TO RELATED APPLICATION

The present application claims the benefit of U.S. Provisional Patent Application Ser. No. 62/338620, filed May 19, 2016. Reference is also made to U.S. Provisional Patent Application Ser. No. 62/338618, filed May 19, 2016, and U.S. Application Ser. No. (Attorney Docket No. 33474-US1, filed May 18, 2017). The disclosures of each of these applications are incorporated herein by reference in their entireties.

### FIELD OF THE DISCLOSURE

The present disclosure relates to methods and systems for associating information related to assay reagents, samples, and consumables.

### BACKGROUND

During the manufacture and use of biological reagents and consumables, products are typically coded and labeled for tracking purposes. Conventional systems use bar codes to identify reagents and consumables, with the bar codes applied to a carrier or vessel supporting the reagent and/or directly affixed to the consumable or to a container housing the consumable. Thereafter, the bar code is read by a bar code reader associated with a system used to conduct an experiment using that reagent or consumable. This enables the system to track the reagents and/or consumables presented to the system. Like bar codes, RFID technology can be used to track reagent or consumable usage. RFID technology offers several advantages to conventional bar code technology in that it does not require an optical path to read the information stored to the RFID and more data can be stored to an RFID. In this regard, reference is made to U.S. Pat. Nos. 7,187,286 and 8,770,471, and U.S. Patent Publication No. 2006/0199196, the disclosures of which are incorporated herein by reference.

Conventional tracking technology can only be used to track the presence of consumables or reagents, but it cannot detect the usage of a reagent and/or sample during the course of an assay. For example, while conventional tracking technology can confirm that each of the components required for use in a given assay are present in an analytical system, e.g., microtiter plates, a vessel including a buffer, reagent, or sample, etc., current tracking systems cannot confirm that the contents of a vessel have been transferred or otherwise mixed with one or more additional components of the assay, e.g., that a given aliquot of sample has been mixed with a particular reagent. However, there is a potential in any assay workflow, whether an assay step(s) or the entire assay is performed manually or in an automated instrument, that through user or instrument error, one or more reagents are not properly dispensed during the course of an assay, thereby raising issues regarding assay and instrument reliability as well as the validity of the assay results. In addition, in manual workflows or steps performed without the aid of automation, the user has to manually track not only the actual reagents and consumables but also the information related to the reagents and consumables as well, e.g., the reagent and consumables specifications, protocols, etc. Therefore, a need exists for tracking technology that confirms more than the mere presence of a consumable and/or reagent at the onset of an assay. It would be beneficial to confirm the usage of reagents and consumables during the course of an assay workflow and be able to store information about the reagents and consumables used in the course of an assay workflow with the reagents and consumables themselves for easy retrieval.

### SUMMARY OF THE DISCLOSURE

Improved assay component tracking compositions and methods are disclosed herein. Therefore, the present disclosure provides a composition including (a) a sample comprising a first set of RF particles that respond to a first unique resonant frequency; and/or (b) one or more reagents comprising a second set of RF particles that respond to a second unique resonant frequency. The sample can include a biological material and the reagent(s) comprises one or more components including, but not limited to, diluent, buffer, calibrator, control, PCR master mix, nucleic acids, nucleotides, oligonucleotides, DNA, RNA, PNA, primers, probes, adapters, antibodies or fragments thereof, antigens, small molecules, streptavidin, avidin, biotin, and combinations thereof.

Still further, provided herein is a composition including one or more of a biological sample and/or reagent having an identifier suspended therein. In a specific embodiment, the composition includes a sample having an identifier suspended therein; alternatively or additionally, the composition includes a reagent having an identifier suspended therein. The composition can also include one or more preservatives, stabilizers, or additives.

One embodiment disclosed hereinbelow is a method of using an assay system for the conduct of an assay of a target in a sample, wherein said assay system is operably connected to (x) a storage medium including an assay data repository comprising an assay protocol script and an associated requirement list comprising reagent and sample requirement information for said assay protocol script; and (y) a reader adapted to read information from an identifier, said method comprising: programming said assay system to conduct an assay according to said assay protocol script; adding a sample to said system, wherein said sample comprises a sample identifier suspended in said sample, wherein the sample identifier comprises sample information; mixing said sample with a reagent in a vessel positioned in said system, wherein said reagent comprises a reagent identifier suspended in said reagent and said reagent identifier comprises reagent information; reading said reagent identifier and said sample identifier in said vessel; comparing said sample and reagent information collected in step (d) with said requirement list; and conducting said assay in said assay system according to said assay protocol script if said comparing step (e) confirms, via said sample and reagent information, that reagent and sample requirements for said assay protocol script have been met.

Also provided is a method of using an assay system for the conduct of an assay of a target in a sample, wherein said assay system is operably connected to (x) a storage medium including an assay data repository comprising an assay protocol script and an associated requirement list comprising reagent and sample requirement information for said assay protocol script; (y) a reader adapted to read information from an identifier, and (z) a user interface; said method comprising: programming said assay system to conduct an assay according to said assay protocol script; adding a sample to said system, wherein said sample comprises a sample identifier suspended in said sample, wherein the sample identifier comprises sample information; mixing said sample with a reagent in a vessel positioned in said system, wherein said reagent comprises a reagent identifier suspended in said reagent and said reagent identifier comprises reagent information; reading said reagent identifier and said sample identifier in said vessel; comparing said sample and reagent information collected in step (d) with said requirement list; and conducting said assay in said assay system according to said assay protocol if said comparing step (e) confirms, via said sample and reagent information, that reagent and sample requirements for said assay protocol script have been met; or prompting a user, via said user interface, to replace and/or replenish one or more of said sample and said reagent if said comparing step (e) fails to confirm, via said sample and reagent information, that reagent and sample requirements for said sample protocol script have been met.

In addition, the disclosure includes a method of using an assay system for the conduct of an assay of a target in a sample, wherein said assay system is operably connected to (x) a storage medium including an assay data repository comprising an assay protocol script and an associated requirement list comprising reagent and sample requirement information for said assay protocol script; and (y) a reader adapted to read information from an identifier; said method comprising: programming said assay system to conduct an assay according to said assay protocol script; adding a sample to said system, wherein said sample comprises a sample identifier suspended in said sample, wherein the sample identifier comprises sample information; mixing said sample with a reagent in a vessel positioned in said system, wherein said reagent comprises a reagent identifier suspended in said reagent and said reagent identifier comprises reagent information; reading said reagent identifier and said sample identifier in said vessel; comparing said sample and reagent information collected in step (d) with said requirement list; adjusting one or more operations performed by said system before, during and/or after the conduct of an assay based on said sample and reagent information; and conducting said assay in said assay system according to said assay protocol if said comparing step (e) confirms, via said sample and reagent information, that reagent and sample requirements for said assay protocol script have been met.

Described below is a method of using an assay system for the conduct of an assay of a target in a sample, wherein said assay system is operably connected to (x) a storage medium including an assay data repository comprising an assay protocol script and an associated requirement list comprising reagent requirement information for said assay protocol script; and (y) a reader adapted to read information from an identifier, said method comprising: programming said assay system to conduct an assay according to said assay protocol script; mixing said sample with a reagent in a vessel positioned in said system, wherein said reagent comprises a reagent identifier suspended in said reagent and said reagent identifier comprises reagent information; reading said reagent identifier in said vessel; comparing said reagent information collected in step (c) with said requirement list; and conducting a step of said assay in said assay system according to said assay protocol script if said comparing step (d) confirms, via said reagent information, that reagent requirements for said step of said assay protocol script have been met.

### BRIEF DESCRIPTION OF THE FIGURES

FIGS. 1A-1B are schematic illustrations of the methods and systems described herein. In FIG. 1A, the assay or system identifies the contents of a vessel or container using the identifiers suspended therein. An additional embodiment is shown in FIG. 1B, wherein the vessels or containers can include a supplemental identifier that uniquely identifies that vessel, and the contents of the vessel also included identifiers suspended therein.

### DETAILED DESCRIPTION OF THE DISCLOSURE

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. The articles “a” and “an” are used herein to refer to one or to more than one (i.e., to at least one) of the grammatical object of the article. By way of example, “an element” means one element or more than one element.

The methods and systems described herein are improvements to conventional reagent, sample, and component tracking methods. Instead of (or in addition to) tracking an identifier affixed to a vessel or container housing a reagent or sample, identifiers are suspended in reagent and/or sample solutions and when the reagent or sample is transferred from one container or vessel to another, the reagent/sample identifiers are transferred as well. All of the identifiers present in the system can be simultaneously or sequentially read in one or more steps, once all components are mixed and prepared for the conduct of an assay so that the system and therefore, the user, can ensure that all reagents and samples are suitably admixed prior to analysis. In one embodiment, all identifiers in a vessel or container can be read simultaneously, whether the identifiers are the same or different. Alternatively, all identifiers in a vessel can be read sequentially. The methods described herein can be accomplished using a suspended identifier uniquely associated with each reagent and sample. Using conventional tracking methods, while the system can track the presence of components in the system, i.e., via identifiers adhered to vessels or containers presented to the system, there is no mechanism to ensure that the reagents or samples housed in those vessels or containers have been transferred or suitably admixed. However, the methods and systems described herein can overcome that deficiency, not only confirming that the required consumables are present in the system, but also, that the correct reagents and samples are present.

As used herein, a “consumable” can be any structure useful in diagnostic applications and that structure can be dictated by the particular assay format or detection method employed. Examples of consumables include, but are not limited to, test tubes, cuvettes, flow cells, assay cartridges and cassettes (which can include integrated fluidics for assay processing), multi-well plates, slides, assay chips, lateral flow devices (e.g., strip tests), flow-through devices (e.g., dot blots), pipette tips, solid phase supports for biological reagents and the like.

The methods described herein can be implemented in an analytical system configured to conduct any type of diagnostic or analytical method known in the art. Such analytical methods include but are not limited to clinical chemistry assays (e.g., measurements of pH, ions, gases and metabolites), hematological measurements, nucleic acid amplification assays (e.g., polymerase chain reaction (PCR) and ligase chain reaction assays), immunoassays (e.g., direct, sandwich and/or competitive immunoassays and serological assays), oligonucleotide ligation assays, sequencing methods, and nucleic acid hybridization assays. In a specific embodiment, the analytical method is a nucleic acid amplification assay, e.g., PCR or ligase chain reaction. Alternatively, the method is an immunoassay, e.g., a direct, sandwich, or competitive immunoassay. The immunoassay can be a serological assay. Still further, the method is a nucleic acid sequencing process. The corresponding system can include a reaction module configured to perform the selected diagnostic assay, as well as memory, a processor, and a display. The reaction module includes one or more sample processing modules and each sample processing module comprises one or more units or stations for carrying out the various steps required to process a sample. If the assay is a nucleic acid amplification assay, the sample processing module can include a reaction chamber and a thermoelectric cooling device, e.g., a thermal cycler, and optionally one or more of the following: a sample dispensing station, a separation station, and one or more consumable and/or reagent storage stations. The reaction chamber is configured to house a sample during one or more nucleic acid amplification reaction steps. In addition, the nucleic acid amplification module also includes at least one control unit electrically connected to one or more of the sample processing modules. The control unit also includes an analysis module configured to analyze a nucleic acid to obtain a detectable signal.

Memory can include any combination of any type of volatile or non-volatile memory, such as random-access memories (RAMs), read-only memories such as an Electrically-Erasable Programmable Read-Only Memory (EEPROM), flash memories, hard drives, solid state drives, optical discs, and the like. Memory can be a single device or it can also be distributed across two or more devices. A processor can include one or more processors of any type, such as central processing units (CPUs), graphics processing units (GPUs), special-purpose signal or image processors, field-programmable gate arrays (FPGAs), tensor processing units (TPUs), and so forth. A processor can be a single device or distributed across any number of devices. The display can be implemented using any suitable technology, such as LCD, LED, OLED, TFT, Plasma, etc. In some implementations, the display may be a touch-sensitive display (a touchscreen).

The system can also be operably connected to one or more computing devices (not shown) such as desktop computers, laptop computers, tablets, smartphones, servers, application-specific computing devices, or any other type(s) of electronic device(s) capable of performing the techniques and operations described herein. In some embodiments, the elements of the system and the subcomponents of each element can be provided in a single device or as a combination of two or more devices together achieving the various functionalities discussed herein. For example, a nucleic acid amplification module may include one or more server computers and one or more client computers communicatively coupled to each other via one or more local-area networks and/or wide-area networks. Finally, the system can also include one or more peripheral devices (e.g., a printer and keyboard), and the computer subsystems can be interconnected via a system bus. Peripherals and input/output (I/O) devices, which couple to an I/O controller, can be connected to the system by any means known in the art, such as a serial port. For example, a serial port or external interface (e.g. Ethernet, Wi-Fi, etc.) can be used to connect the system to a wide area network such as the Internet, a mouse input device, or a scanner. The interconnection via system bus allows the central processor to communicate with each subsystem and to control the execution of instructions from system memory or the storage device(s), as well as the exchange of information between subsystems. The system memory and/or the storage device(s) may embody a computer readable medium.

A computer system can include a plurality of the same components or subsystems, e.g., connected together by external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present disclosure can be implemented in the form of control logic using hardware (e.g. an application specific integrated circuit or field programmable gate array) and/or using computer software with a generally programmable processor in a modular or integrated manner. As used herein, a processor includes a multi-core processor on an integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices. Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive, a CD, or an entire computer system), and may be present on or within different computer program products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

As used herein, “reagent” includes but is not limited to, any biological reagent that might be used in an analytical method, e.g., solutions comprising one or more of the following: detergent, buffer, diluent, calibrators, controls, co-reactants, enzymes, water, inorganic or organic solvents, nucleic acids, nucleotides (dNTPs or ddNTPs), oligonucleotides, DNA, RNA, PNA, primers, probes, adapters, aptamers, antibodies or fragments thereof, antigens, small molecules, e.g., drugs or prodrugs, streptavidin, avidin, and biotin, and mixtures thereof. Generally, “reagent” includes any substance apart from a biological sample that is used in the preparation for and/or conduct of an assay, including but not limited to, a nucleic acid amplification assay (e.g., PCR), a nucleic acid sequencing process, an immunoassay, a cellular assay, etc. In a specific embodiment, “reagent” includes a reagent used in a nucleic acid amplification reaction, e.g., PCR Master Mix and reagents required for isothermal amplification, including but not limited to, DNA polymerase, e.g., Taq polymerase, dNTPs, MgCl₂, buffers, helicase, nicking enzyme, or mixtures thereof. In another embodiment, “reagent” includes a reagent used in a sequencing process and/or library preparation process, including but not limited to, sequencing adapters, controls, primers, DNA polymerase, dNTPs, labeled ddNTPs, molecular tags, expression vector(s), template, ligase master mix, etc. An additional embodiment is a cellular assay, e.g., an assay described in U.S. Pat. No. 9,481,903, which is incorporated herein by reference, wherein a “reagent” can include but is not limited to, a population of engineered transduction particles, a biologic or abiologic vector, bacterial nutrient media, buffers, surfactant, or other components to facilitate cell growth. A further embodiment is a “reagent” used in an immunoassay, e.g., antibodies or fragments thereof, antigens, bovine serum albumin, streptavidin, avidin, biotin, labeled assay components, e.g., components including a radiolabel, chemiluminescent label, electrochemiluminescent, or luminescent label, fluorophore, etc., immunoassay coreactants, e.g., tertiary amines (if the assay is an electrochemiluminescent assay, a coreactant including tripropyl amine is used in the assay), etc. Additionally, a reagent in an assay can comprise an identifier conjugated to the reagent via a non-reactive substance inert to the conditions of the assay protocol.

Likewise, “sample” refers to any emulsion, suspension, or liquid sample matrix including a biological material that can be analyzed in the assay systems described above. As used herein, “sample” includes, but is not limited to samples containing or derived from, for example, cells (live or dead) and cell-derived products, immortalized cells, cell fragments, cell fractions, cell lysates, organelles, cell membranes, hybridoma, cell culture supernatants (including supernatants from antibody producing organisms such as hybridomas), waste or drinking water, food, beverages, pharmaceutical compositions, blood, serum, plasma, hair, sweat, urine, feces, tissue, biopsies, effluent, separated and/or fractionated samples, separated and/or fractionated liquids, organs, saliva, animal parts, animal byproducts, plants, plant parts, plant byproducts, soil, minerals, mineral deposits, water, water supply, water sources, filtered residue from fluids (gas and liquid), swipes, absorbent materials, gels, cytoskeleton, protein complexes, unfractionated samples, unfractionated cell lysates, endocrine factors, paracrine factors, autocrine factors, cytokines, hormones, cell signaling factors and or components, second messenger signaling factors and/or components, cell nucleus/nuclei, nuclear fractions, chemicals, chemical solutions, structural biological components, skeletal (ligaments, tendons) components, separated and/or fractionated skeletal components, hair, fur, feathers, hair fractions and/or separations, skin, skin samples, skin fractions, dermis, endodermis, eukaryotic cells, prokaryotic cells, fungus, yeast, antibodies, antibody fragments, immunological factors, immunological cells, drugs, therapeutic drugs, oils, extracts, mucous, fur, oils, sewage, environmental samples, organic solvents or air. The sample may further comprise, for example, water, organic solvents or mixtures thereof. The sample can also include nucleic acid (e.g., DNA or RNA) that has been isolated from a biological material. The sample can be purified, in whole or in part.

The samples contemplated herein can be fresh, refrigerated, frozen, reconstituted, and/or combined with one or more preservatives, stabilizers, or additives.

“Component” is referred to herein as any reagent, sample, or consumable that can be used in an assay system. Certain types of information stored to an identifier is referred to herein as “component information” because that information can relate to a reagent, sample or consumable and it is not distinguished by the type of component.

An “identifier” is a storage medium comprising memory to store information related to the sample, reagent, and/or consumable, e.g., its history and/or its use. In a specific embodiment, the identifier is an RFID, i.e., radio frequency identification. With RFID, the electromagnetic or electrostatic coupling in the RF portion of the electromagnetic spectrum is used to transmit signals.

RFIDs can be classified as active or passive. Active RFID systems have three essential components: (a) a reader, transceiver or interrogator, (b) antenna, and (c) a transponder or IC programmed with information. Active RFID tags possess a microchip circuit (transponder or IC) and an internal power source, e.g., a battery, and when operably connected to an antenna, the active RFID tag transmits a signal from the microchip circuit through the power obtained from the internal battery. In general, two different types of active RFID tags are commercially available: transponders and beacons. In a system that uses an active transponder, the reader sends a signal and when the antenna and tag are operably connected, the tag will send a signal back with the relevant information programmed to the transponder. In a system that uses an active beacon, the beacon will send out a signal on a periodic basis and it does not rely on the reader's signal.

Passive systems also comprise (a) a reader, transceiver or interrogator, (b) antenna, and (c) a tag programmed with information. A passive RFID tag includes a microchip or integrated circuit (IC), and it may contain the antenna as an integral component of the tag or as a separate device, but in a passive RFID system the tag does not include a power source . In one configuration of a passive system, the antenna can be an internal component of the tag, i.e., the antenna and IC can be contained in a single device instead of segregated into separate devices, but until operably connected in the device, the antenna and IC do not interact. Alternatively, the antenna and IC can be provided on separate components as described above regarding the active RFID systems. As the name implies, passive tags wait for a signal from an RFID reader. The reader sends energy to an antenna which converts that energy into an RF wave that is sent into the read zone. Once the tag is read within the read zone, the RFID tag's internal antenna draws in energy from the RF waves. The energy moves from the tag's antenna to the IC and powers the chip which generates a signal back to the RF system. This process is called backscatter. The backscatter, or change in the electromagnetic or RF wave, is detected by the reader (via the antenna), which interprets the information. Passive RFID tags have no internal power source and a standard passive RFID tag consists of an IC and internal antenna; this basic structure is commonly referred to as an RFID inlay. Countless other types of passive RFID tags exist on the market, but all tags generally fall into two categories—inlays or hard tags. Hard RFID tags are durable and made of plastic, metal, ceramic and even rubber. They come in all shapes and sizes and are typically designed for a unique function, material, or application.

Passive RFID tags do not all operate at the same frequency. There are several frequencies within which passive RFID tags operate. The frequency range, along with other factors, strongly determines the read range, attachment materials, and application options.
125-134 KHz—Low Frequency (LF)
5-7 MHz—High Frequency (HF)
13.56 MHz—HF & Near-Field Communication (NFC)
433 MHz—Ultra-High Frequency (UHF)
865-960 MHz—UHF
2.4 GHz—UHF
5.2-5.8 GHz—UHF

In a specific embodiment in which a passive RFID system is used, an UHF frequency is used, e.g., of between 1.0-3.0 GHz, particularly, 1.5, 2.0, and/or 2.45 GHz.

In one embodiment, the RFID components are located in the same unit. Alternatively, the RFID components can be located on different constituents and the RFID is operable when the RFID components are in sufficient proximity to read the detectable signal and transfer the information to a processing device. In a specific embodiment, the RFID system comprises an antenna tuned to a unique resonant frequency, such that each reagent and sample in the system are each tuned to a unique resonant frequency distinguishable from the frequencies of other components in the system. The frequencies of each set of RF particles can be read sequentially or simultaneously. In a specific embodiment, the antenna can comprise carbon single-walled nanotubes and the unique resonant frequency of the antenna is adjustable by modifying the length of the nanotubes.

RFID technology can also be supplemented in the present methods and systems using one or more conventional identifiers, e.g., bar codes, EPROM, EEPROM, ICC, flash memory, or combinations thereof. For example, reagents or samples can include suspended RFID identifiers and one or more containers, vessels, or compartments used in the system, e.g., in the preparation for and/or conduct of an assay in the system can be labeled with a supplemental identifier, e.g., one or more RFID, bar codes, EPROM, EEPROM, ICC, flash memory, or combinations thereof. In this embodiment, the system is operably connected to a plurality of readers each configured to read information from a distinct type of identifier. Certain information can be stored on one identifier and other information on an additional identifier of the same or different type. For example, a reagent and/or sample can include suspended RFIDs that include reagent and sample information, respectively, e.g., the type of reagent and/or sample, and for a sample, patient identification information, whereas the container housing the reagent or sample can include another identifier, e.g., a bar code or other type of non-volatile memory, used to store additional information. For example, if the container houses a reagent, a bar code can be included on the container with reagent information comprising manufacturer information or lot specific parameters for that reagent.

Active and/or passive RFID systems are available from Motorola, Alien Technology, Applied Wireless RFID, CAEN RFID, GAO RFID, Impinj, Mojix, NXP Semiconductors, ThingMagic, Avery Dennison, Invengo, Omni-ID, Confidex, Metalcraft, and Smartrac Technology. In a specific embodiment, the RFID system is a system such as that provided by Philtech, Inc. (Tokyo, Japan) or Hitachi Ltd. (Japan). The Philtech system is described, e.g., in Mura et al., “RF-Powder: Fabrication of 0.15-mm Si-powder Resonating at Microwave Frequencies” Proceedings of the 37th European Microwave Conference, Oct. 2007, pp. 392-395, as well as U.S. Application/Patent Nos. 20080198000; 7,777,631; 7,839,276; 7,997,495; 8,237,622; 8,154,456; 8,178,415; 8,766,802; 8,766,853; and the Hitachi system is described in U.S. Application/Patent Nos. 20060077062; 7,378,971; and Nozawa, “Hitachi Achieves 0.05-mm Square Super Micro RFID Tag, ‘Further Size Reductions in Mind’” Nikkei Technology, Tech & Industry Analysis from Japan/Asia online, Feb. 20, 2007, the disclosures of which are incorporated herein by reference.

For example, U.S. Pat. No. 8,766,802 to Philtech, Inc. the disclosure of which is incorporated herein by reference, relates to a base data management system that includes a base data reader including reading means that reads specific data of particles fixed to a base and transmitting means that transmits the specific data read by the reading means and reader information. The system also includes a computer including data receiving means that receives the specific data and reader information transmitted from the base data reader through a network, storage means that stores the specific data and reader information received by the data receiving means, and output means that processes the data stored in the storage means according to the application and outputs the processed data. The system includes a base data reader that reads specific data of a base and transmits the specific data and reader information, and a computer that receives and stores the specific data and reader information transmitted from the base data reader through a network, and outputs the data and information as required.

U.S. Pat. No. 8,766,802 describes a base used in a base data management system (see, e.g., FIG. 2 of U.S. Pat. No. 8,766,802, the disclosure of which is incorporated herein by reference in its entirety). The base depicted in the figure includes an RF powder. In the embodiment shown, a single type of a large number of RF powder particles are disposed on a surface of a base by printing or the like. The RF powder particles respond to a high frequency electromagnetic field having a single frequency. The “RF powder” refers to a powder comprised of a large number of particles, each having an electrical circuit element that transmits and receives signals to or from external readers by radio (in a high frequency electromagnetic field). The particles are generally treated as a powder collectively.

In the present context, a quantity of RF powder particles are suspended in a volume of a sample or reagent. In a specific embodiment, the method is used to form a composition including a sample mixed with an aliquot of a first set of RF particles that respond to a first unique resonant frequency and a reagent is mixed with an aliquot of a second set of RF particles that respond to a second unique resonant frequency. When the sample and reagent are mixed, during the course of an assay, the presence and/or absence of the first and second frequencies are used to detect/confirm the usage of the sample and reagent in the assay workflow. In another specific embodiment, a composition is formed including a sample and/or reagent having a quantity of RF powder particles suspended therein. In a particular embodiment, the composition does not include an additional identifying component used to identify the unique resonant frequency of the RF particles in the composition.

Various additional embodiments of this method are also contemplated. For example, two or more reagents can be mixed, each including a distinct set of RF particles (a first and a second set of RF particles, respectively). When the two reagents are mixed, e.g., during the course of an assay or in preparation for an assay, the presence and/or absence of the first and second frequencies associated with each of the first and second set of RF particles are used to detect/confirm the usage of each of the reagents in the workflow. In a specific example, in a library preparation method, two or more sequencing adapters are used, the first adapter composition including a suspension of a first set of RF particles that respond to a first unique frequency, and a second adapter composition including a suspension of a second set of RF particles that respond to a second unique frequency. When the two compositions are mixed, each of the adapters can be detected during the course of the workflow that follows via the RF signals of each set of particles.

In one embodiment, a concentration of RF powder particles of up to 100 particles per consumable is present in the composition including sample and/or reagent. In a specific embodiment, a concentration of up to 50 particles, more particularly, up to 10 particles, and as little as 1 particle is present in the composition. The approximate concentration of RF powder particles is independent of the volume of liquid in the consumable.

Reference is also made to U.S. Pat. No. 8,318,047 to Philtech, Inc., the disclosure of which is incorporated herein by reference in its entirety, which discloses an RF powder-containing liquid, i.e., water, alcohol, or ink, which contains a large amount of RF powder particles mixed with a pigment to distinguish the characteristic frequency of the RF powder suspended in the liquid from another liquid having a different frequency and pigment. Reference is further made to U.S. Pat. No. 8,154,456 to Philtech, Inc., the disclosure of which is incorporated herein by reference in its entirety.

In the RF powder particle, an insulating layer (SiO2 or the like) is formed on, for example, a silicon (Si) substrate, and a plural-turn coil (inductance element) and a capacitor (capacitance element) are formed on the insulating layer by a film-forming technique. The coil and the capacitor formed on the insulating layer are coupled with a high frequency magnetic field having a specific frequency (for example, 2.45 GHz) and resonate. The number of turns and the length of the coil are arbitrarily set to obtain an intended resonance frequency. The shape of the coil may also be changed. The pad electrodes of the capacitor, and the dielectric material disposed between the pad electrodes and its thickness can also be appropriately designed according to an intended frequency. Moreover, the RF powder particle responds to only a high frequency electromagnetic field depending on the resonance frequency of the tank circuit. Thus, the RF power particle functions as a “powder circuit element” that is coupled with a magnetic field of a designed frequency to resonate.

The RFID reader/writer has a read terminal and reads information provided from the RF powder particles using radio-frequency electromagnetic waves (RF) in a specific frequency band, e.g., ranging from about 1.0-3.0 GHz, e.g., 1.5-2.5 GHz. The frequencies used in each of the plurality of RF powder particles can be different from each other, for example, one set of particles can use 1.9 GHz, a second set uses 2.0 GHz, and a third set uses 2.45 GHz. Hence, the RFID reader/writer is configured to read the electromagnetic waves of, for example, 1.5 to 3.0 GHz frequency band. In order to read information from each of the plurality of RF powder particles via the read terminal, the reader/writer performs a scanning operation in a certain direction along the outside of the vessel or container, and also changes the frequency used for transmission/reception within the specific frequency band. Only those particles that use the specific frequency band being scanned will generate a detectable signal, i.e., respond to the electromagnetic wave at the specific frequency band. Therefore, if there are three different sets of particles in a vessel, the first using 1.9 GHz, the second using 2.0 GHz, and the third using 2.45 GHz, when the read/writer performs a scanning operation at 2.0 GHz, only the second set of particles will respond to the read/writer, but the first and third sets of particles will not.

The substrate of a base of the RF powder particle is made of silicon, and is provided with the insulating layer over the surface thereof. As an alternative to the silicon substrate, a substrate made of a dielectric (insulative) material, such as glass, a resin, or a plastic, may be used. If a glass substrate or the like is used, the insulating layer is not necessary because the material of such a substrate is intrinsically insulative (dielectric). Specific examples of RF powder particles and methods of making and using them can be found, inter alia, in U.S. Pat. No. 8,318,047, e.g., FIGS. 4-10 and the accompanying description spanning columns 4-10, the disclosure of which is incorporated herein by reference.

In a specific embodiment, the RFID system comprises an antenna tuned to a unique resonant frequency, such that each reagent and sample in the system are each tuned to a unique resonant frequency distinguishable from the frequencies of other components in the system. In one embodiment, the antenna can comprise carbon single-walled nanotubes and the unique resonant frequency of the antenna is adjustable by modifying the length of the nanotubes.

In an alternative or additional embodiment, the identifier system includes a microtransponder tag, e.g., a p-Chip® (available from Pharma Seq, Inc., Monmouth Junction, N.J.), which are ultra-small identifers that carry a unique serial number. These identifiers are approximately 500×500 microns and nominally 100 microns thick. Unlike RFID technology, instead of using radio frequency detection, microtransponder tags include photocells that, when illuminated by light from a reader, provide power and synchronization signals for the tag's electronic circuits. Additionally, each tag includes an on-chip antenna that transmits its unique serial number when stimulated by pulsed, laser light. Therefore, as applied to the methods described herein if a microtransponder tag is used the system operates much like a passive RFID system, in that in the absence of target, the antenna and IC are not operably connected but upon complex formation, the IC is operably connected to the antenna and powered to transmit a unique serial number upon stimulation. Therefore, in this embodiment, the detectable signal is the transmission of information, e.g., a unique serial number. In this embodiment, the reader can identify the tag via the unique serial number and query a storage medium on the system or network for additional component information associated with that serial number, e.g., the assay protocol script and the associated requirements list.

The reader controls the operation of the non-volatile memory and other components of the assay system. For example, the reader optionally includes or is operably connected to a micro-controller to interface with the non-volatile memory over a communication interface, which can incorporate conventional interface architectures and protocols such as I^{2C}, a two line serial bus protocol. The microcontroller addresses the non-volatile memory and performs write, read and erase operations on the memory.

As used herein, identifiers are suspended in a volume of reagent or sample. In this regard, identifier constituents are mixed with but undissolved in the reagent or sample. In one embodiment, the identifier can be encapsulated in a material that does not adhere to the walls of a vessel housing the sample or reagent. Moreover, the identifiers can be coated with material that mimics biological material (antibodies, bovine serum albumin, etc.) that will be transferred when the vessel fluid volume is transferred.

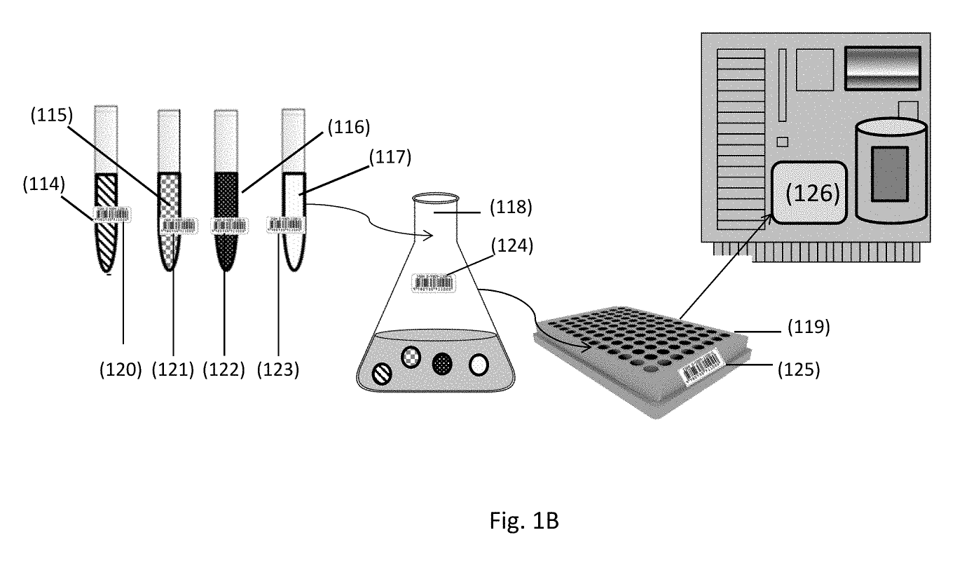

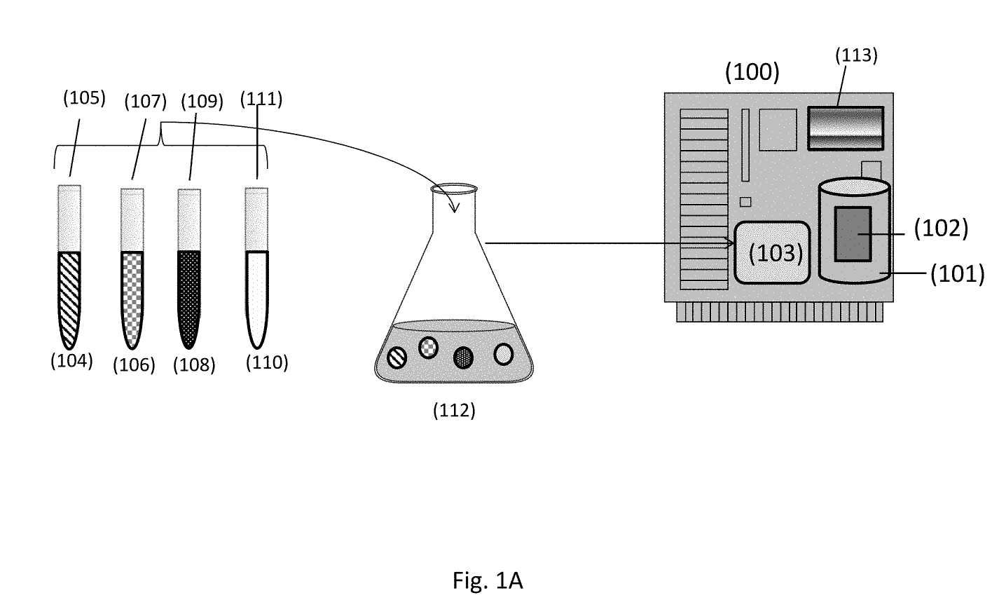

An illustration of the method and an associated system is provided in FIGS. 1A-1B. In FIG. 1A, an assay system (100) is operably connected to a storage medium (101) including a data repository (102) comprising one or more assay protocol scripts (not shown) and for each script, an associated requirement list (not shown) including the reagent and sample requirements for that protocol, e.g., the identity and quantity of each reagent and sample. The system is also operably associated with a reader (103) adapted to read information from an identifier. In one embodiment, the storage medium, data repository, and reader are components of the assay system. Alternatively, at least the storage medium and/or the data repository can be remotely connected to the system, e.g., over a computer network. The reader can be an internal or external component of the system. In one embodiment, the assay system is pre-programmed to identify the assay protocol that will be used by the system and the system queries the data repository to identify the associated requirement list for that assay protocol. Alternatively, the system can identify an assay protocol based on the sample and/or reagent information read from the identifiers and query the data repository for the associated requirement list after the identifiers have been read by the reader.

In a first step, sample (104) is prepared by suspending a quantity of sample identifiers (105) in the sample solution, and likewise, one or more reagents ((106), (108), and (110)) are prepared by suspending a quantity of reagent identifiers (107), (109), and (111), respectively) in reagent solutions. Therefore, each sample and reagent is uniquely labeled using a distinct sample and/or reagent identifier. The sample/reagent preparation steps can be done offline, i.e., before the samples or reagents are placed in the system, or by the system or a sample preparation subsystem operatively associated with the system. As described in more detail below, the sample identifier comprises sample information uniquely identifying the sample, e.g., sample type, patient identification information, sample collection information, etc., and likewise, the reagent identifier comprises reagent information uniquely identifying each reagent, e.g., reagent type, supplier, manufacturing information, such as manufacturing date, lot, or batch number, etc. A volume of sample and one or more reagents are combined in a vessel (112) such that the mixture includes one or more sample identifiers and reagent identifiers, and the pool of identifiers in the vessel are read by the reader (103). The system compares the associated requirements list with the information collected from the identifiers to determine whether the required sample and reagents have been presented to the system for the conduct of an assay according to the selected assay protocol. If the system can confirm that the reagent and sample requirements of the assay protocol have been met based on the sample and reagent information presented via the identifiers, the system will conduct an assay according to the assay protocol. If the system cannot confirm that the reagent and sample requirements of the assay protocol have been met, the system will display an error message, e.g., on a graphical user interface operably connected to the system (113). In an alternative embodiment, if the reagent and sample requirements of the assay protocol have not been met, in addition to or as an alternative to displaying an error message, the system can adjust the quantity of sample and/or reagent in accordance with the assay protocol and associated requirements list so that the quantity of each component, based on the identifiers present, is aligned with the assay protocol and associated requirements list.

In an additional embodiment, one or more vessels or containers used to store or house samples or reagents that may contain identifiers can include supplemental identifiers. For example, as shown in FIG. 1B, the assay or system may manipulate samples or reagents in a one or more test tubes, flasks, microwell or microtitre plates (114-119, respectively), and each such vessel or container can include a supplemental identifier that uniquely identifies that vessel (120-125, respectively). The reader (126) associated with the assay system can read the information stored to each of the identifiers and supplemental identifiers and compare that information to the requirements list. In a specific embodiment, the sample and one or more reagents are uniquely labeled using suspended RFIDs and consumables used in the conduct of an assay, e.g., test tubes, flasks, a microwell plate or reaction chip, are labeled with a supplemental identifier, e.g., a bar code or RFID.

The system reads the sample, reagent, and/or consumable information stored to the sample, reagent, and consumable identifiers and that information is used by the system to identify the sample, reagent and/or consumable (referred to collectively as “components”). The system reviews the component information stored locally on the system in the local storage medium to identify that information stored to the storage medium that can be used for the conduct of an assay using a given component. If the storage medium includes the information for that component, e.g., the assay script protocol and associated requirements list, and the system can verify that the correct set of components are present in the system for a given assay script, the system will commence running an assay. If the storage medium does not include information for those particular components, the system can query the user for that component information and the user can communicate with the vendor to receive the requisite information, e.g., via email, compact diskette, memory card/stick, flash drive, web data storage service, etc. The vendor sends component information binary files (including but not limited to encrypted XML files) to the user, e.g., as an email attachment to a user email account, the user loads that file attachment to the assay system and the system software stores the component information to the local system component information repository. The components can then be used in the system.

In an alternative embodiment, the database can be connected to the system via a direct interface which can automatically obtain the component information from the database if it is not available on the system locally. Thereafter the system software queries the system data repository for the component information associated with that component identifier and if that component information is available locally on the system, the software will adjust the system based on the component information, if necessary. If the component information is not present in the local system data repository, the system will either (i) prompt the user to manually obtain the component information from the vendor, or (ii) automatically, via a direct interface with the remote database, obtain the component information from the remote database and store that information locally on the system data repository. Once the component information is available locally on the system, the software adjusts the system based on the component information, if necessary, and conducts an assay.

The system can adjust the assay parameters prior to initiating an assay based on the information saved to the identifier(s) and/or stored or provided via a direct or indirect interface. Thereafter, the system makes the appropriate electrical, fluidic and/or optical connections (making use of electrical, fluidic and/or optical connectors on the consumable and system) and conducts an assay using the components. The assay can also involve adding one or more assay reagents to a component, e.g., a reaction vessel, and instructions for adding those various assay reagents can be saved to the identifier and/or provided as component information and the system adds those reagents to the component before or during the assay according to the instructions saved to the component identifier and/or provided as component information.

In one embodiment, the assay system includes one or more processors configured to adapt the system and various sub-systems based on a selected assay protocol and the components required for that protocol. The assay system is also operably connected, directly or indirectly, to a storage medium and a reader adapted to read information from a component identifier. In one illustrative embodiment, the storage medium includes a protocol data table and a requirements data table and when a user selects a desired assay protocol to be run on the system or when the system detects a particular component identifier in the system that includes information related to a desired assay protocol, the processor queries the protocol data table and the requirements data table to identify the components required for a given assay protocol. The requirements data table includes the set of components, e.g., sample, reagent, and consumables, required for a given assay protocol, as wells as information about each of the components required, i.e., sample information, reagent information and consumable information, as defined herein. The reader scans the identifiers presented to the system, e.g., suspended identifiers as well as supplemental identifiers, to collect the set of component information associated with the presented identifiers and the processor compares the set of component information with that in the requirements list. If all required components are present in the system, the system will commence the assay protocol. If one or more components are not present or if there is a discrepancy between the components presented and the requirements, the system will display an error message to the user on the system user interface.

In addition, the methods described herein can also be used to monitor a change in component information at each step of a protocol to confirm efficient workflow of the system in the conduct of an assay or a step thereof. For example, a reagent, e.g., a buffer or diluent, can be supplied to a system with a predetermined quantity of suspended identifiers. As the reagent is used during the course of an assay or a series of assays in the system, the quantity of suspended identifiers present in the reagent vessel can be monitored and if the quantity falls below a predetermined threshold, the system alerts the user, e.g., via the graphical user interface, that the reagent should be replenished or that there is insufficient reagent to conduct additional assays. Alternatively, a similar method can be used to monitor usage of a sample that is analyzed in a series of assays, each assay requiring a small aliquot from a larger sample container. After one or more aliquots of sample are extracted from the sample container, the quantity of suspended identifiers is assessed by the reader and if the quantity falls below a predetermined threshold, the sample alerts the user that the sample should be replenished or that there is insufficient sample to conduct additional assays.

Each sample, reagent, or consumable can be associated with a unique individual identifier. Alternatively or additionally, a common identifier can be used for a given type of reagent, sample, or consumables used on the system, and the system can track usage of that consumable by tracking a ratio of one type of identifier relative to another. For example, as shown in the table below, for assay 1 that uses Sample 51 and Reagent R1, each including a different identifier, A and B, respectively, when the sample is mixed with the reagent according to a defined protocol, the experimental ratio of identifier A to B (relative to a known ratio for the protocol) can be used to assess whether the components have been adequately mixed according to the protocol. In the example illustrated in the table below, for assay 1, the protocol dictates that that Sample S1 is present in two fold excess relative to Reagent R1; therefore, the ratio of A:B is 2:1. If the experimentally determined ratio of A:B differs from 2:1, then there has been a deviation from the assay protocol. Likewise, multiple reagents can be combined with a sample and the ratio of each component relative to the others can be evaluated, as shown in relation to Assay 2 below (in the protocol depicted in the table, for Assay 2, the sample is present in two fold excess relative to Reagents R2 and R3).

| Assay | Sample and Reagents present | Mixture Ratio |
|---|---|---|
| Assay 1 | S1, R1 | 2:1 |
| Assay 2 | S1, R2, R3 | 2:1:1 |

While a unique RFID tag with a distinct resonant frequency can be generated for each component of an assay, one can also specifically track components using a more limited number of RFID tags using a mixture of RFIDs and a predefined ratio of RFIDs as the unique signature for a given component. For example, three distinct RFID tags (tags 1, 2, and 3) can be generated for a component, set of components, etc., each having a unique resonant frequency (Tag 1 has Frequency 1; Tag 2 has Frequency 2; and Tag 3 has Frequency 3). The three tags can be combined in unique ratios to generate component-specific RFID combination signatures. Therefore, a first sample can be mixed with a defined ratio of tags 1, 2, and 3 mixed, e.g., in a relative ratio of 25:25:50. A second sample can be mixed with a second defined ratio of tags 1, 2, and 3 mixed in a relative ratio of 25:50:25. The first and second samples are distinguishable from one another because the relative ratios of the three tags suspended in the samples serve as unique RFID signatures. Additional examples are shown in the table below:

| Sample | RFID Signature Ratio of Tag 1:Tag 2:Tag 3 |
|---|---|
| 1 | 25:25:50 |
| 2 | 25:50:25 |
| 3 | 50:25:25 |
| 4 | 10:45:45 |
| 5 | 45:10:45 |
| 6 | 45:45:10 |
| 7 | 10:30:60 |
| 8 | 10:60:30 |
| 9 | 60:30:10 |
| 10 | 60:10:30 |
| 11 | 30:60:10 |
| 12 | 30:10:60 |

The methods described herein can be used to identify a sample, reagents, etc. subjected to any suitable storage condition. For example, if a biological or environmental sample is collected for subsequent evaluation or use, prior to storage for a short or long duration, the sample can be mixed with an identifier including sample information that can be read and later used to identify the sample. In a specific embodiment, a sample of ova, sperm, fertilized eggs, embryos, whole blood, plasma, biopsy tissue, etc., can be collected, suitably admixed with one or more preservatives, stabilizers, or additives for long or short term storage, as needed, a unique RFID tag is suspended in the sample matrix, and the sample is then stored, e.g., fresh, refrigerated, frozen, etc. Upon retrieval, the RFID is read and the sample information stored to the RFID is immediately available. This enables a larger amount of sample information to be stored with the sample itself, avoiding the need to cross-reference the sample with one or more paper or electronic files stored elsewhere, separately. In a specific embodiment, the sample can be mixed with a cryoprotectant to protect the biological contents of the sample from freezing damage, including but not limited to, antifreeze components, antifreeze proteins, glycols, e.g., ethylene glycol, propylene glycol, or glycerol, dimethyl sulfoxide, trehalose, sucrose, sodium phosphates, 2-methyl-2,4-pentanediol, etc.

### Sample, Reagent and/or Consumable Information

The identifiers can be programmed with information which can be used before, during or after an assay or a step of a multi-step assay to control the operation of the assay system or a subsystem thereof. The terms “sample information,” “reagent information,” and “consumable information” can include any information used to uniquely identify a particular reagent, sample, or consumable or to distinguish a reagent, sample, or consumable from other components in the system. “Component information” is also used herein to refer to any sample, reagent, or consumable information that is not defined by the type of component.

### Component Information

Component information can include but is not limited to component type, component identification information, the date of manufacture, lot number, expiration date, assay names and/or identifiers, information concerning assay quality control, calibration information such as a master calibration curve, the number and names of assay calibrators and/or assay calibrator acceptance ranges, clinical trial information, formulation information, the identity of and/or results obtained from diagnostic tests performed on the component, supplier information, lot identification information, lot specific analysis parameters, manufacturing process information, raw materials information, expiration date, Material Safety Data Sheet (MSDS) information, product insert information (i.e., any information that might be included or described in a product insert that would accompany the component, e.g., the assay type, how the assay is performed, directions for use of the component, etc.), and/or threshold and/or calibration data for a component.

Component information can also relate to chain of custody, e.g., information regarding the control, transfer and/or analysis of the sample, reagent, and/or an assay consumable. Chain of custody information can be selected from customer identification, sample identification, time and date stamp for an assay, custody and/or location information for the component before and after the conduct of the assay, assay results for a given sample, as well as customer created free text comments input before, during or after an assay is processed by the system using that component. Still further, chain of custody information can include time, date, manufacturing personnel or processing parameters for one or more steps during the manufacture of the component, custody, location and/or storage conditions for the component following manufacture and/or between steps during the manufacture of the component.

Still further, component information can be used as a security mechanism, e.g., to confirm that the correct reagent, sample, or consumable is being used in the system. The information can include a digital signature to prove that the component was manufactured by the designated vendor. In one embodiment, if an inappropriate consumable is present in the system, e.g., a counterfeit consumable or a consumable that is otherwise incompatible with the assay system, the controller will disable the system, reader or a subsystem thereof. In addition or alternatively, the information can be used to detect the proper placement of an assay consumable in the system, e.g., the proper orientation of the assay consumable or a portion thereof, in the assay system, such that the controller will disable the system, reader or a component thereof until the assay consumable is placed in the correct orientation. Still further, the information can also be used to detect a defect in the assay consumable or an assay test site and/or domain and the controller will disable the system, reader or a component thereof accordingly. In a further embodiment, the component can be subjected to a quality control process during or after its manufacture and the results of that quality control analysis can be written to the identifier for later use and/or verification by the customer of the component in an assay reader.

The component information can also include authorization information for samples, reagents, and/or consumables or test site and/or domain thereof, such as information regarding whether a particular customer has a valid license to use a particular component, including the number of times the customer is permitted to use the particular component in a particular assay and the limitations, if any, on that use, e.g., whether the customer's license is for research purposes only. Such information can also include validation information regarding whether a particular component has been subject to a recall or has otherwise become unsuitable or unauthorized for use. The recall information and an optional last recall check date and/or timestamp can be written to the identifier and/or provided as information.

The component information can further include information regarding the origin of a biological reagent used in a component, test site and/or domain, including for example an identification of an original sample from which it was derived or the number of generations removed it is from an original sample. For example, if an assay reagent used in an assay is an antibody, the information can include the identification of the hybridoma from which the antibody was derived, e.g., the ATCC accession number for that hybridoma.

According to various embodiments, biological samples or reagents that are provided in or with the consumables described above can be licensed separately from systems designed to operate on the biological reagents. In various embodiments the assay system, reader or a component thereof is coupled to a network that allows the system to communicate over public and/or private networks with computer systems that are operated by or on behalf of the customers, manufacturers and/or licensors of the biological reagents, consumables or systems. In various embodiments, a limited license can provide for the use of licensed biological reagents, consumables or systems for a particular biological analysis on only licensed systems. Accordingly, a system can authenticate a biological reagent, consumable or system based on, for example, a digital signature contained in the identifier associated with a particular consumable and/or provided as information, if a particular customer has a valid license. In various embodiments, the identifier and/or information can also be used to provide for a one time use such that biological reagents cannot be refilled for use with the same authentication.

In certain embodiments, when the identifier is read by a system, reader or component thereof that has access to a public or private data network operated by or on behalf of the customers, manufacturers and/or licensors of the biological reagents, consumables or systems, certain information can be communicated to the assay system and read, written or erased locally via the identifier/controller on the assay system. For example, recall and/or license information can be a subset of information that is available via a direct and/or indirect interface, whereas additional information e.g., lot-specific, expiration date, calibration data, component specific information, assay results information, component security information, or combinations thereof, can be stored locally on the identifier and otherwise unavailable via the network connections on the assay system. In one embodiment, recall, license and/or component security information can be available via the network connections on the assay system and/or stored to the storage medium as information and the remaining information is stored locally on the identifier. The assay system or reader includes system hardware, system firmware, system data acquisition and control software, and method or information. In various embodiments, the system hardware includes electronic control and data processing circuitry, such as a microprocessor or microcontroller, memory, and non-volatile storage. In various embodiments, the system hardware also includes physical devices to manipulate biological reagents such as robotics and sample pumps. In various embodiments, the system firmware includes low-level, computer-readable instructions for carrying out basic operations in connection with the system hardware. In various embodiments, the system firmware includes microprocessor instructions for initializing operations on a microprocessor in the system hardware.

In addition, the component information can include assay process information concerning the individual assay parameters that should be applied by the system during an assay using that component. For example, such information can include a sequence of steps for a given assay, the identity, concentration and/or quantity of assay reagents that should be used or added during the assay or during a particular step of an assay, e.g., buffers, diluents, and/or calibrators that should be used in that assay. The information can also include the type or wavelength of light that should be applied and/or measured by the system during the assay or a particular step of a multi-step assay; the temperature that should be applied by the system during the assay; the incubation time for an assay; and statistical or other analytical methods that should be applied by the system to the raw data collected during the assay.

In one embodiment, one or more steps of an assay protocol can be tailored to an individual component or lot of components. One or more steps of a protocol can differ from component lot to lot and/or from individual component to component within a given lot and the information stored to the system includes instructions to tailor those steps of the assay protocol. This type of information can be used by the system to adjust one or more operations performed by the system before, during and/or after the conduct of an assay by the system. Moreover, this type of information can optionally be adjusted by the system user at the user's discretion. For example, dilution steps in an assay protocol can be adjusted to account for lot to lot or component to component differences. The amount of diluent added and/or the nature of the diluent can be altered based on such differences. Similarly, the amount of a given reagent that can be added during the conduct of an assay, an incubation period and/or temperature for one or more steps of an assay can also be dependent on lot to lot or component to component differences. Each of these is a non-limiting example of information that can be saved to the storage medium of the system.

Moreover, the information comprises information that directly or indirectly controls a component of the assay system, e.g., one or more photodetectors, a light tight enclosure; mechanisms to transport the component into and out of the system; mechanisms to align and orient the components with the one or more subsystem(s); additional mechanisms and/or data storage media to track and/or identify components, mechanisms to transfer, store, stack, move and/or distribute one or more components; mechanisms to detect signal from a consumable during the assay sequentially, substantially simultaneously or simultaneously from a plurality of test sites of the consumable; or combinations thereof.

The information can also include assay process information comprising assay parameters to be applied by the system during the assay; a sequence of steps to be applied by the system during the assay; the identity, concentration, and/or quantity of assay reagents to be used or added during the assay; the temperature to be applied by the system during the assay; an incubation time for the assay; statistical or analytical methods to be applied by the system to raw data collected during the assay; or combinations thereof (such assay process information can optionally be adjusted by the user). In one specific embodiment, the assay conducted with the consumable is a multi-step assay and the assay process information relates to a step or step(s) of the multi-step assay.

In addition, a given assay protocol can require a set of components of a particular type. Therefore, if the user inputs a specific type of component, e.g., a multi-well assay plate, for use in a particular assay protocol, one or more additional components can be required to carry out that assay protocol in the system, e.g., one or more reagents can be required for use with that multi-well assay plate. Each of the required components can include an identifier with information concerning the component requirements for an assay protocol. When one of the required components is input into the assay system and the reader interacts with the identifier for that component, the system will take an inventory of the components present in the system and compare the results to the requirements list stored to the identifier and/or stored to the storage medium and/or provided as information. If any required components are not present or are present in insufficient supply, the system will prompt the user to input the additional required components for that assay protocol.

In another embodiment, the component information further includes one or more analytical tools that can be applied by the system to analyze data generated during and/or after the conduct of an assay. In addition, such analytical tools can include instructions for the user and/or the system to generate a specific output by the system software after the conduct of an assay, e.g., a tailored data report and/or format for the results of the analysis based on the information. Alternatively or additionally, the analytical tools can further include one or more statistical algorithms that can be applied by the system to the data. For example, the component information can include a selection of two or more statistical algorithms that can be used to analyze data resulting from use of a given component and the user can optionally select the appropriate algorithm for the desired data analysis. The information can also include information that can be used by the user to select the appropriate algorithm for his or her needs, e.g., technical notes or literature references related to algorithm selection.

Analytical tools can differ from component lot to lot and/or from individual component to component within a given lot. In this embodiment, the information is used by the system to adjust the analytical processing tools applied by the system software in the conduct of an assay or after the assay is completed and the results are generated and/or displayed. Such analytical processing tools include but are not limited to assay thresholds and/or calibration curves that can be applied to one or more steps of an assay protocol that can also be altered based on component differences. In a specific embodiment, for a given component type and/or desired use, the information can include a project management tool that schedules the conduct of one or more assays or steps thereof using a given component in the system or with a set of components. Still further, such analytical processing tools can optionally be adjusted by the system user at the user's discretion. Analytical tools can be sent to the user via a direct or indirect interface between the system and the user.

### Reagent Information

Reagent information can include but is not limited to reagent type, formulation, the date of manufacture, lot number, expiration date, reagent chain of custody information, associated assay names and/or identifiers, information concerning reagent quality control, calibration information such as a master calibration curve, the number and names of assay calibrators and/or assay calibrator acceptance ranges, supplier information, lot identification information, lot specific analysis parameters, manufacturing process information, raw materials information, expiration date, Material Safety Data Sheet (MSDS) information, product insert information (i.e., any information that might be included or described in a product insert that would accompany the reagent, e.g., the assay type, how the assay is performed, directions for use of the reagent, etc.), and/or threshold and/or calibration data for a reagent.

### Sample Information

Sample information can include sample type, patient identification information, clinical trial information (i.e., information about a clinical trial for which the sample has been collected), sample collection information, sample chain of custody information, sample formulation information, the identity of and/or results obtained from additional diagnostic tests performed on the sample, and combinations thereof. Sample information can also include a patient's personal history information, e.g., if the sample is an egg or sperm donation, the sample information can include but is not limited to, information regarding the donor's blood type, medical history, family medical history, race, height, weight, health and eye color, age, family history, educational background, etc.

The present application is not to be limited in scope by the specific embodiments described herein. Indeed, various modifications in addition to those described herein will become apparent to those skilled in the art from the foregoing description and accompanying figures. Such modifications are intended to fall within the scope of the claims. Various publications are cited herein, the disclosures of which are incorporated by reference in their entireties.

What is claimed:

1. A composition comprising one or more of a biological sample or reagent, wherein said composition further comprises an identifier suspended therein.

2. The composition of claim 1 wherein the identifier comprises an RFID.

3. The composition of claim 1 wherein said reagent is a biological reagent.

4. The composition of claim 1 wherein said reagent comprises nucleic acids, nucleotides, oligonucleotides, DNA, RNA, PNA, primers, probes, antibodies or fragments thereof, antigens, small molecules, streptavidin, avidin, biotin, and combinations thereof.

5. The composition of claim 1 wherein the reagent comprises a diluent or buffer.

6. The composition of claim 1 wherein the reagent comprises a PCR master mix.

7. The composition of claim 1 wherein the reagent is a calibrator and/or a control.

8. The composition of claim 1 wherein the biological sample comprises cells, cell-derived products, immortalized cells, cell fragments, cell fractions, cell lysates, organelles, cell membranes, hybridoma, cell culture supernatants, blood, serum, plasma, hair, sweat, urine, feces, tissue, biopsies, effluent, and combinations thereof.

9. A composition comprising (a) a biological sample comprising a first set of RF particles that respond to a first unique resonant frequency; and (b) a reagent comprising a second set of RF particles that respond to a second unique resonant frequency.

10. The composition of claim 9 wherein said reagent comprises one or more components including diluent, buffer, calibrator, control, PCR master mix, nucleic acids, nucleotides, oligonucleotides, DNA, RNA, PNA, primers, probes, antibodies or fragments thereof, antigens, small molecules, streptavidin, avidin, biotin, and combinations thereof.

11. The composition of claim 9 further comprising a biological sample and one or more preservatives, stabilizers, or additives.

12. The composition of claim 9 wherein the identifier is present at a concentration of up to 100 particles per volume of said composition.

13. The composition of claim 9 wherein the identifier is present at a concentration of up to 10 particles per volume of said composition.

14. The composition of claim 9 wherein said identifier comprises RF powder particles.

15. The composition of claim 1 further comprising a cryoprotectant.

16. A method of using an assay system for the conduct of an assay of a target in a sample, wherein said assay system is operably connected to (x) a storage medium including an assay data repository comprising an assay protocol script and an associated requirement list comprising reagent and sample requirement information for said assay protocol script; and (y) a reader adapted to read information from an identifier, said method comprising:
a. Programming said assay system to conduct an assay according to said assay protocol script;
b. Adding a sample to said system, wherein said sample comprises a sample identifier suspended in said sample, wherein the sample identifier comprises sample information;
c. Mixing said sample with a reagent in a vessel positioned in said system, wherein said reagent comprises a reagent identifier suspended in said reagent and said reagent identifier comprises reagent information;
d. Reading said reagent identifier and said sample identifier in said vessel;
e. Comparing said sample and reagent information collected in step (d) with said requirement list; and
f. Conducting said assay in said assay system according to said assay protocol script if said comparing step (e) confirms, via said sample and reagent information, that reagent and sample requirements for said assay protocol script have been met.

17. The method of claim 15 wherein said vessel comprises a vessel identifier and said reading step further comprises reading said vessel identifier.

18. The method of claim 15 wherein said identifier is an RFID.

19. The method of claim 15 wherein said assay comprises clinical chemistry assays, hematological measurements, nucleic acid amplification assays, immunoassays, oligonucleotide ligation assays, nucleic acid sequencing processes, or nucleic acid hybridization assays.

20. The method of claim 15 wherein said reagent is a biological reagent.
